(19) United States
(12) Patent Application Publication
(10) Pub. No.: US 2015/0043250 A1
(43) Pub. Date: Feb. 12, 2015

(54) CIRCUIT FOR DRIVING POWER SWITCH, POWER SUPPLY APPARATUS AND METHOD FOR DRIVING POWER SWITCH

(71) Applicant: SAMSUNG ELECTRO-MECHANICS CO., LTD., Suwon-si (KR)

(72) Inventors: Hwan CHO, Suwon-si (KR); Jung Chul GONG, Suwon-si (KR); Jung Hyun KIM, Suwon-si (KR)

(73) Assignee: SAMSUNG ELECTRO-MECHANICS CO., LTD., Suwon-si (KR)

(21) Appl. No.: 14/282,796

(22) Filed: May 20, 2014

(30) Foreign Application Priority Data
Aug. 12, 2013 (KR) 10-2013-0095417

(51) Int. Cl. H02M 3/335

(52) U.S. Cl. CPC H02M 3/33553
USPC 363/21.09

(57) ABSTRACT

The present invention relates to a circuit for driving power switch, a power supply apparatus, and a method for driving a power switch. According to an embodiment of the present invention, a circuit for driving power switch, which includes a variable oscillator for varying a frequency according to a change in primary side input voltage to output a reference signal for duty control; and a duty control unit for receiving a feedback signal fed back from a secondary side output signal and the reference signal for duty control from the variable oscillator and outputting a duty control signal for driving a power switch, is provided. Further, a power supply apparatus and a method for driving a power switch are provided.

### CROSS-REFERENCE TO RELATED APPLICATIONS

Claim and incorporate by reference domestic priority application and foreign priority application as follows:

### “CROSS REFERENCE TO RELATED APPLICATION

This application claims the benefit under 35 U.S.C. Section 119 of Korean Patent Application Serial No. 10-2013-0095417, entitled filed Aug. 12, 2013, which is hereby incorporated by reference in its entirety into this application.”

### BACKGROUND OF THE INVENTION

1. Field of the Invention

The present invention relates to a circuit for driving power switch, a power supply apparatus, and a method for driving a power switch, and more particularly, to a circuit for driving power switch, a power supply apparatus, and a method for driving a power switch that can vary a frequency of a reference signal for duty control of a power switch according to an input voltage.

2. Description of the Related Art

A switch mode power supply (hereinafter, SMPS) is a device that receives a rectified input voltage, generates an output voltage desired by a user through on-off operations of a switch, and supplies a current required for a load. An inevitable power loss occurs during the on-off operations of the switch, and the power loss is related to an input voltage and a switching frequency. The higher the input voltage and the switching frequency, the greater the loss, and the lower the input voltage and the switching frequency, the smaller the loss.

Two types of switching losses of a power switch used as an SMPS switch are shown in FIGS. 3a and 3b as an example. The switching loss occurs in a transient period in which on-off are switched. The longer the transient period (including the case in which the number of the transient periods is increased) or the higher the drain to source voltage (hereinafter, Vds), the amount of power loss is increased by the formula [power=voltage×current×time]. FIG. 3a shows that the power loss is increased due to the increases in the Vds and the on-off transient period according to the increase in the burden voltage of source-drain terminals, and FIG. 3b shows that the power loss is increased due to the increase in the number of the transient periods per unit time according to the increase in the switching frequency. Since the Vds of the SMPS is structurally increased according to the increase in the input voltage, the power loss is increased.

### RELATED ART DOCUMENT

### Patent Document

Patent Document 1: U.S. Patent Publication No. US2010/0053999 A1 (laid open on Mar. 4, 2010)
Patent Document 2: Korean Patent Publication No. 10-2009-0021672 (laid open on Mar. 4, 2009)

### SUMMARY OF THE INVENTION

In order to overcome the above-described problems, an input voltage is detected and a switching frequency is reduced when the input voltage is high in order to compensate a power loss due to an increase in the input voltage. However, since an SMPS has a specific switching frequency according to design characteristics of the system, the frequency cannot be reduced unconditionally to reduce losses. Therefore, the frequency should be reduced under the condition that various circumstances permit and it doesn't matter since the reduction of the maximum power caused by the reduction of the frequency is offset by the characteristic that the maximum power increases when the input voltage is high.

The present invention has been invented in order to overcome the above-described problems and it is, therefore, an object of the present invention to provide a technology that can improve a switching loss by varying a frequency of a reference signal for duty control of a power switch according to an input voltage.

In accordance with a first aspect of the present invention to achieve the object, there is provided a circuit for driving power switch including: a variable oscillator for varying a frequency according to a change in primary side input voltage to output a reference signal for duty control; and a duty control unit for receiving a feedback signal fed back from a secondary side output signal and the reference signal for duty control from the variable oscillator and outputting a duty control signal for driving a power switch.

At this time, in an example, the variable oscillator may include a triangular wave generator for generating a triangular wave signal of which the frequency varies depending on a switching operation of an oscillator switch according to the output reference signal for duty control; and a comparator for inputting and comparing the signal according to the primary side input voltage and the triangular wave signal output from the triangular wave generator, and outputting the reference signal for duty control of which the frequency varies according to the change in the primary side input voltage and the change in the frequency of the triangular wave signal.

At this time, at this time, in another example, the variable oscillator may further include a buffer amplifier for receiving the signal of the primary side input voltage to transmit the received signal to the comparator.

In addition, at this time, in another example, the triangular wave generator may include a current source; a charging and discharging capacitor connected to the current source and generating the triangular wave signal by repeating charging and discharging using the current source as a power supply for charging according to the switching operation; and the oscillator switch connected in parallel to the charging and discharging capacitor on a lower end of the current source, performing the switching operation according to the reference signal for duty control, discharging a charging voltage of the charging and discharging capacitor to a ground when turned on, and performing charging to the charging and discharging capacitor from the current source when turned off.

Further, in an example, the variable oscillator may reduce the frequency of the reference signal for duty control when the primary side input voltage is increased to output the reference signal for duty control of which the frequency is reduced.

At this time, in another example, the circuit for driving power switch may further include a feedback circuit unit for receiving the detected secondary side output signal to feed back the feedback signal to the duty control unit; and a switch driving unit for outputting a driving signal for driving a power switch according to the duty control signal of the duty control unit.

Next, in accordance with a second aspect of the present invention to achieve the object, there is provided a power supply apparatus including: a transformer for generating a secondary side output voltage by receiving a primary side input voltage; a secondary output block connected to a secondary side of the transformer to supply a secondary side output signal to a load; a circuit for driving power switch according to one of the above-described embodiments of the first aspect of the present invention; and a power switch driven by the circuit for driving power switch.

At this time, in an example, a variable oscillator of the circuit for driving power switch may reduce the frequency of the reference signal for duty control when the primary side input voltage is increased to output the reference signal for duty control of which the frequency is reduced.

Further, in an example, the circuit for driving power switch may further include a voltage division unit for dividing the primary side input voltage to provide the divided voltage to the variable oscillator; a feedback circuit unit for detecting the secondary side output signal to feed the feedback signal back to the duty control unit; and a switch driving unit for outputting a driving signal for driving the power switch according to a duty control signal of the duty control unit.

Next, in accordance with a third aspect of the present invention to achieve the object, there is provided a method for driving a power switch, including the steps of: generating and outputting a reference signal for duty control of which the frequency varies according to a change in primary side input voltage; and generating and outputting a duty control signal for driving a power switch after receiving a feedback signal fed back from a secondary side output signal and the reference signal for duty control.

At this time, in an example, the step of generating and outputting the reference signal for duty control may include the steps of: receiving and comparing the signal according to the primary side input voltage and a fed-back triangular wave signal, and outputting the reference signal for duty control, which is generated as a result of the comparison, for generation of the duty control signal and applying the reference signal for duty control to an oscillator switch at the same time; and generating the triangular wave signal of which the frequency varies depending on a switching operation of the oscillator switch according to the application of the reference signal for duty control and feeding back the triangular wave signal for comparison.

Further, at this time, in another example, the step of generating and outputting the reference signal for duty control may further include the step of in a buffer amplifier, receiving the signal of the primary side input voltage to transmit the received signal for comparison with the fed-back triangular wave signal.

Further, in an example, the step of generating and outputting the reference signal for duty control may reduce the frequency of the reference signal for duty control when the primary side input voltage is increased to output the reference signal for duty control of which the frequency is reduced.

At this time, in another example, the method for driving a power switch may further include the steps of: receiving the detected secondary side output signal and outputting the feedback signal for generation of the duty control signal; and generating and outputting a driving signal for driving a power switch according to the duty control signal output in the step of generating and outputting the duty control signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a power supply apparatus including a circuit for driving power switch in accordance with an embodiment of the present invention;

FIG. 2 is a circuit diagram schematically showing a power supply apparatus including a circuit for driving power switch in accordance with another embodiment of the present invention;

FIGS. 3a and 3b are views schematically explaining a typical switching loss of a power switch;

FIG. 4 is a view showing a way of reducing a frequency of a reference signal for duty control according to an increase in input voltage in a circuit for driving power switch in accordance with an embodiment of the present invention;

FIG. 5 is a flowchart schematically showing a method for driving a power switch in accordance with another embodiment of the present invention;

FIG. 6 is a flowchart schematically showing a method for driving a power switch in accordance with another embodiment of the present invention; and

FIG. 7 is a flowchart schematically showing a method for driving a power switch in accordance with another embodiment of the present invention.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

First, a circuit for driving power switch in accordance with a first aspect of the present invention will be specifically described with reference to the drawings. At this time, the reference numeral that is not mentioned in the reference drawing may be the reference numeral that represents the same element in another drawing.

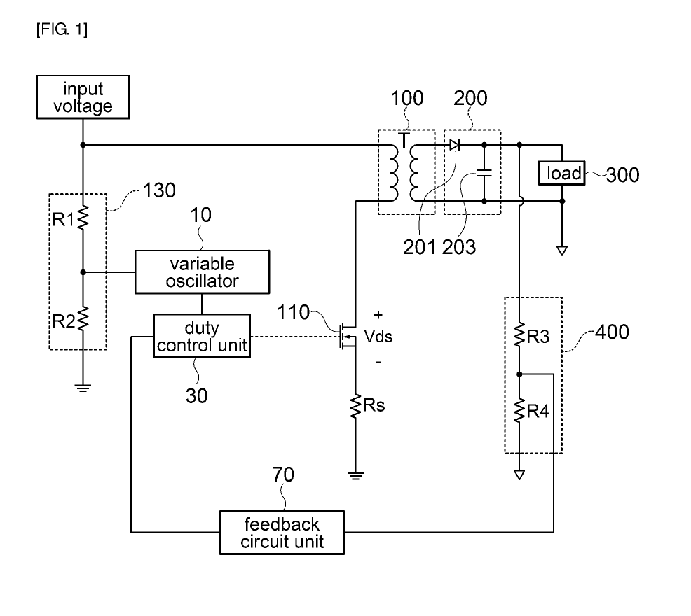

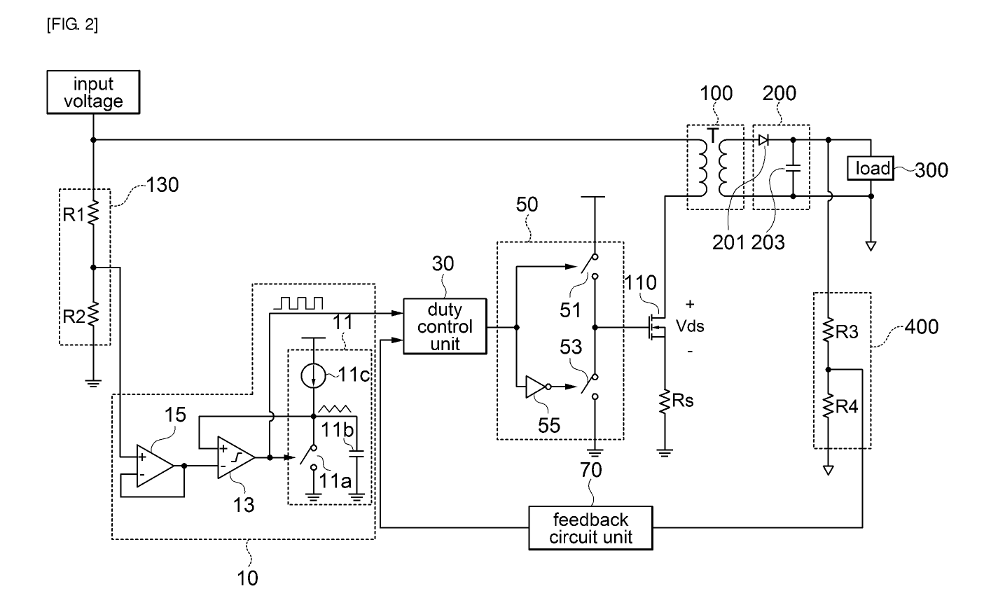

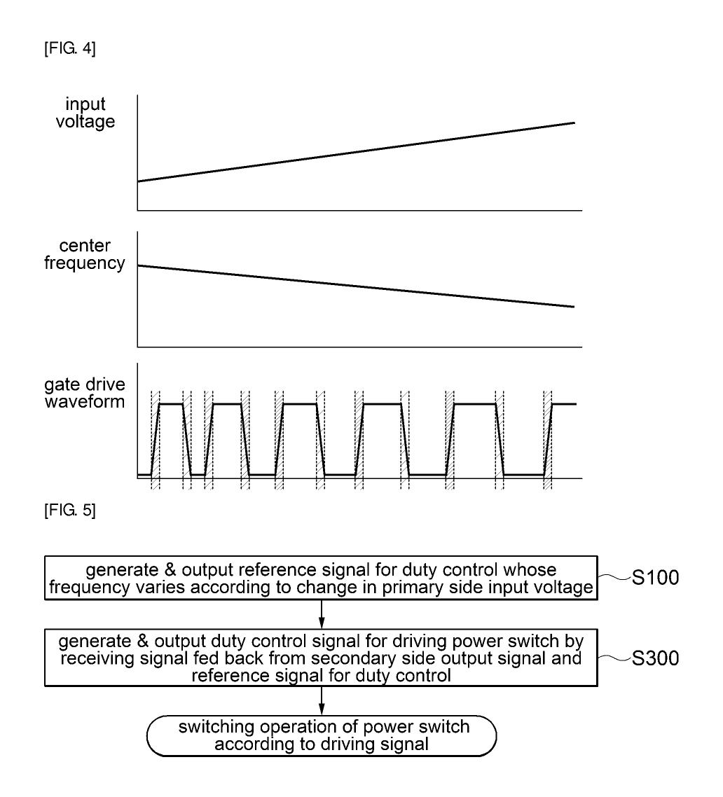

FIG. 1 is a view schematically showing a power supply apparatus including a circuit for driving power switch in accordance with an embodiment of the present invention, and FIG. 2 is a circuit diagram schematically showing a power supply apparatus including a circuit for driving power switch in accordance with another embodiment of the present invention. FIG. 4 is a view showing a way of reducing a frequency of a reference signal for duty control according to an increase in input voltage in a circuit for driving power switch in accordance with an embodiment of the present invention.

Referring to FIGS. 1 and/or 2, a circuit for driving power switch according to an example includes a variable oscillator 10 and a duty control unit 30. Further, referring to FIG. 2, in an example, the circuit for driving power switch may further include a feedback circuit unit 70 and a switch driving unit 50. Hereinafter, each component will be specifically described with reference to FIGS. 1 and/or 2.

First, the variable oscillator 10 will be described with reference to FIGS. 1 and/or 2. The variable oscillator 10 varies a frequency according to a change in primary side input voltage to output a reference signal for duty control. That is, in the embodiment of the present invention, for example, the variable oscillator 10 varies a frequency of a reference signal for controlling a duty of a power switch 110 of a power supply apparatus or a DC-DC converter according to a change in primary side input voltage of the power supply apparatus or the DC-DC converter.

In the present embodiment, the variable oscillator 10 is provided to adjust a frequency of a signal for driving the power switch 110 according to the primary side input voltage. For example, a primary side input voltage of an SMPS, which is a power supply apparatus, is input to the variable oscillator 10 which generates a reference frequency of a power switch driving signal, and the variable oscillator 10 adjusts the reference frequency of the driving signal according to the primary side input voltage. Accordingly, the higher the primary side input voltage, the lower the frequency of the driving signal of the power switch 110.

The primary side input voltage is monitored and input to the variable oscillator 10 directly or through resistance division. At this time, as the primary side input voltage increases, for example, an output of a buffer amplifier 15 increases. Thus, a reference voltage input to an inverting terminal (‘-’ terminal) of a comparator 13 increases. Since this means that it takes a longer time to invert an output of the comparator 13, the frequency of the reference signal for duty control, which is an output signal of the variable oscillator 10, decreases.

For example, referring to FIG. 4, in an example, the variable oscillator 10 may output the reference signal for duty control by reducing the frequency of the reference signal for duty control when the primary side input voltage increases. That is, when the primary side input voltage is high, the frequency of the driving signal for turning on-off the power switch 110 may be reduced. Accordingly, it is possible to improve a switching loss of the power switch 110 by offsetting a ‘switching loss increment’ according to the increase in the input voltage and a ‘switching loss decrement’ according to the reduction in the frequency. Referring to FIG. 4, the higher the primary side input voltage, the lower the frequency of the reference signal for duty control generated by the variable oscillator 10, and the lower the frequency of the driving signal of the power switch 110, the smaller the on-off switching interval per unit time. Accordingly, it is possible to improve the switching loss by offsetting the ‘switching loss increment’ according to the increase in the input voltage by the ‘switching loss decrement’ according to the reduction in the frequency.

The variable oscillator 10 will be described in more detail with reference to FIG. 2. Referring to FIG. 2, in an example, the variable oscillator 10 may include a triangular wave generator 11 and a comparator 13. Further, in an example, the variable oscillator 10 may further include an amplifier, for example, a buffer amplifier 15.

The triangular wave generator 11 of the variable oscillator 10 will be described with reference to FIG. 2. The triangular wave generator 11 generates a triangular wave signal according to a switching operation of an oscillator switch 11a. At this time, the oscillator switch 11a performs the switching operation according to the reference signal for duty control output to the duty control unit 30. At this time, a frequency of the generated triangular wave signal varies when a switching frequency of the oscillator switch 11a is changed. That is, specifically, the triangular wave generator 11 generates and outputs the triangular wave signal, of which the frequency varies according to the change in the switching frequency, according to the switching operation of the oscillator switch 11a.

At this time, the triangular wave generator 11 will be described in more detail with reference to FIG. 2. Referring to FIG. 2, the triangular wave generator 11 may include a current source 11c, a charging and discharging capacitor 11b, and the oscillator switch 11a. At this time, the charging and discharging capacitor 11b is connected to the current source 11c and repeats charging and discharging according to the switching operation using the current source 11c as a power supply for charging. The triangular wave signal is generated by the repetition of charging and discharging of the charging and discharging capacitor 11b. The triangular wave signal may be detected from a connection node of the current source, the charging and discharging capacitor 11b, and the oscillator switch 11a.

The oscillator switch 11a is connected in parallel to the charging and discharging capacitor on a lower end of the current source 11c. Referring to FIG. 2, one end of the oscillator switch 11a may be connected to a connection node between the current source 11c and the charging and discharging capacitor 11b, and the other end thereof may be connected to a ground. For example, the oscillator switch 11a may be a MOSFET switch. Further, the oscillator switch 11a performs the switching operation according to the reference signal for duty control output from the comparator 13 described below. At this time, the switching frequency of the oscillator switch 11a may vary according to the reference signal for duty control with a variable frequency. The oscillator switch 11a discharges a charging voltage of the charging and discharging capacitor 11b to the ground when turned on and charges the charging and discharging capacitor 11b from the current source when turned off. The triangular wave signal is generated by the switching operation of the oscillator switch 11a and the charging and discharging of the charging and discharging capacitor 11b, and the frequency of the triangular wave signal varies according to the change in the switching frequency of the oscillator switch 11a.

Next, the comparator 13 of the variable oscillator 10 will be described with reference to FIG. 2. The comparator 13 receives the signal according to the primary side input voltage and the triangular wave signal output from the triangular wave generator 11 to compare them. For example, the signal according to the primary side input voltage input to the comparator 13 may be a signal output through the buffer amplifier 15. Further, the triangular wave signal may be a variable frequency signal fed back from the triangular wave generator 11 according to the output of the reference signal for duty control of the comparator 13. The comparator 13 generates the reference signal for duty control through the comparison between the signal according to the primary side input voltage and the triangular wave signal. At this time, the comparator 13 may generate and output the reference signal for duty control of which the frequency varies according to the change in the primary side input voltage and the change in the frequency of the triangular wave signal.

Further, referring to FIG. 2, in another example, the variable oscillator 10 may further include the buffer amplifier 15. At this time, the buffer amplifier 15 is a voltage follower that receives the signal of the primary side input voltage to transmit the received signal to the comparator 13. For example, at this time, the buffer amplifier 15 may receive the primary side input voltage signal detected by a voltage division unit 130 which divides the primary side input voltage. At this time, the voltage division unit 130 may consist of division resistors R1 and R2.

Again, the duty control unit 30 of the circuit for driving power switch will be described with reference to FIGS. 1 and/or 2. The duty control unit 30 receives a feedback signal fed back from a secondary side output signal and the reference signal for duty control from the variable oscillator 10 and outputs a duty control signal for driving the power switch. The duty control unit 30 generates and outputs the duty control signal of which the frequency as well as duty varies through the comparison with the feedback signal since it receives the reference signal for duty control with the variable frequency. According to the duty control signal of which the frequency as well as duty varies, the driving frequency and duty of the power switch 110 are changed. At this time, for example, it is possible to improve the switching loss of the power switch 110 by offsetting the switching loss increment according to the increase in the input voltage by the switching loss decrement according to the reduction in the frequency.

Continuously, the circuit for driving power switch according to another example will be described with reference to FIGS. 1 and/or 2. At this time, referring to FIGS. 1 and/or 2, the circuit for driving power switch may further include the feedback circuit unit 70 and the switch driving unit 50.

Referring to FIGS. 1 and/or 2, for example, the feedback circuit unit 70 outputs the feedback signal to the duty control unit 30 by receiving the secondary side output signal detected from a secondary side of the power supply apparatus or the DC-DC converter. For example, the feedback circuit unit 70 may receive the secondary side output signal detected from an output voltage division unit 400. At this time, the output voltage division unit 400 may divide and detect the secondary side output signal output from a secondary output block of the power supply apparatus or the DC-DC converter.

In addition, referring to FIG. 2, the switch driving unit 50 outputs the driving signal for driving the power switch 110 according to the duty control signal of the duty control unit 30. For example, the switch driving unit 50 may consist of a digital output circuit such as a flip-flop although not shown or an analog circuit including first and second MOSFETs 51 and 53 as shown in FIG. 2. For example, referring to FIG. 2, the switch driving unit 50 may include the first MOSFET 51 and the second MOSFET 53. The first MOSFET 51 is operated by a high signal of the duty control signal output from the duty control unit 30 and applies the driving signal to the power switch 110 to turn on the power switch 110. Further, the second MOSFET 53 is operated by a low signal of the duty control signal and turns off the power switch 110. For example, referring to FIG. 2, both of the first MOSFET 51 and the second MOSFET 53 are NMOS switches, and the switch driving unit 50 may be formed by adding an inverter 55 to a gate terminal of the second MOSFET 53. Otherwise, although not shown, the first MOSFET 51 may be an NMOS switch and the second MOSFET 53 may be a PMOS switch to form the switch driving unit 50 without the inverter 55.

Next, a power supply apparatus in accordance with a second aspect of the present invention will be described in detail with reference to the drawings. At this time, the circuits for driving a power switch according to the above-described embodiments of the first aspect of the present invention and FIG. 4 will be referenced. Thus, repeated descriptions may be omitted.

FIG. 1 is a view schematically showing a power supply apparatus including a circuit for driving power switch in accordance with an embodiment of the present invention, and FIG. 2 is a circuit diagram schematically showing a power supply apparatus including a circuit for driving power switch in accordance with another embodiment of the present invention.

Referring to FIGS. 1 and/or 2, a power supply apparatus according to an example may include a transformer 100, a secondary output block 200, a circuit for driving power switch, and a power switch 110. Each component will be described in detail. At this time, the circuit for driving power switch will refer to the above-described embodiments of the first aspect of the present invention.

Referring to FIGS. 1 and/or 2, the transformer 100 generates a secondary side output voltage by receiving a primary side input voltage. The transformer 100 includes a primary side winding and a secondary side winding.

Further, the secondary output block 200 is connected to a secondary side of the transformer 100 to provide a secondary side output signal to a load 300. For example, the secondary output block 200 may include a rectifier diode 201 which rectifies the output signal from the secondary side of the transformer 100 and a charging capacitor 203 which charges the secondary side output signal rectified by the rectifier diode 201. At this time, the load 300 may be connected to the secondary output block 200. Further, an output voltage division unit 400, which divides the secondary side output voltage, may be connected to the secondary output block 200.

In addition, the circuit for driving power switch outputs a driving signal for driving the power switch 110 from a feedback signal fed back from the secondary side output signal and a reference signal for duty control of which the frequency varies according to the primary side input voltage. For example, referring to FIGS. 1 and/or 2, the circuit for driving power switch may include a variable oscillator 10 and a duty control unit 30. At this time, the variable oscillator 10 outputs the reference signal for duty control by varying a frequency thereof according to a change in the primary side input voltage. Further, the duty control unit 30 outputs a duty control signal for driving the power switch by receiving the feedback signal fed back from the secondary side output signal and the reference signal for duty control from the variable oscillator 10. The driving signal for driving the power switch 110 is output according to the duty control signal for driving the power switch. Detailed descriptions will refer to the above-described embodiments of the first aspect of the present invention.

At this time, in an example, the variable oscillator 10 of the circuit for driving power switch may reduce the frequency of the reference signal for duty control when the primary side input voltage is increased to output the reference signal for duty control of which the frequency is reduced.

Further, referring to FIGS. 1 and/or 2, in an example, the circuit for driving power switch may further include a voltage division unit, a feedback circuit unit 70, and a switch driving unit 50. At this time, the voltage division unit divides the primary side input voltage and provides the divided and detected primary side input voltage to the variable oscillator 10. Further, the feedback circuit unit 70 outputs the feedback signal to the duty control unit 30 by receiving the secondary side output signal detected from a secondary side of the power supply apparatus. In addition, the switch driving unit 50 outputs the driving signal for driving the power switch 110 according to the duty control signal of the duty control unit 30.

Continuously, referring to FIGS. 1 and/or 2, the power switch 110 of the power supply apparatus is driven by the circuit for driving power switch. The primary side input is transmitted to the secondary side through the transformer 100 according to the driving of the power switch 110 to generate and output the secondary side output voltage.

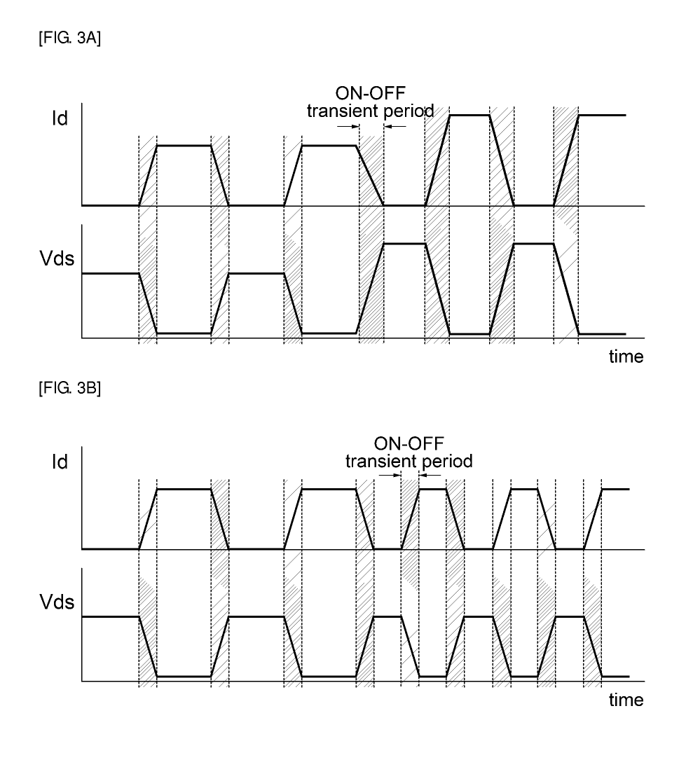

Next, a method for driving a power switch in accordance with a third aspect of the present invention will be described in detail with reference to the drawings. At this time, the circuits for driving a power switch according to the above-described embodiments of the first aspect and FIGS. 1 to 4 will be referenced. Thus, repeated descriptions may be omitted.

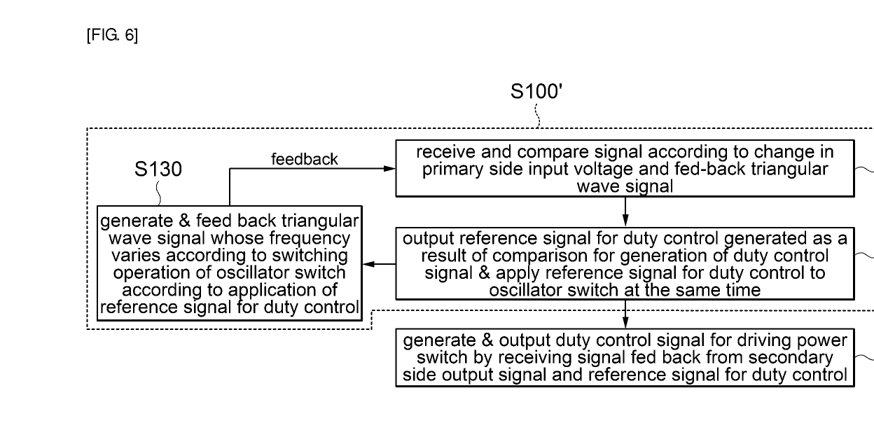

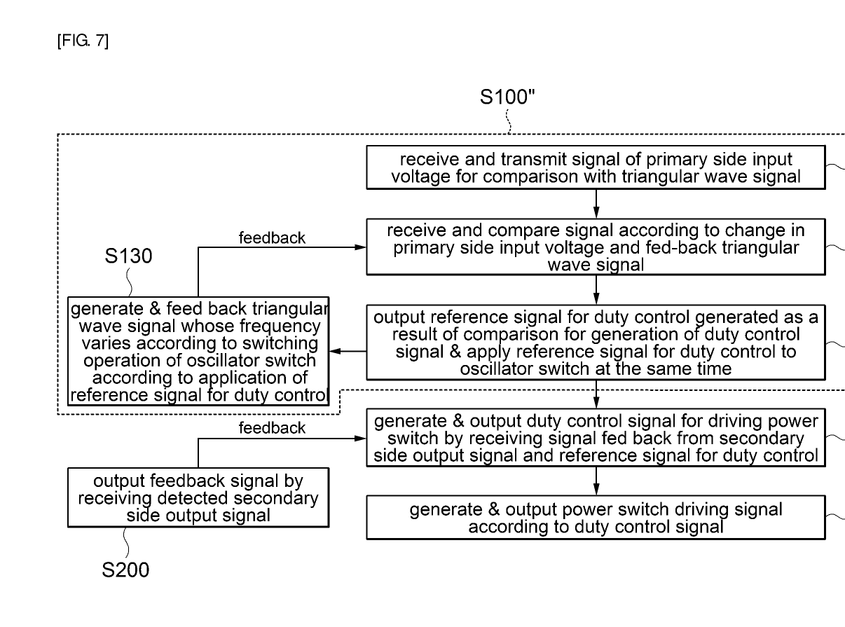

FIG. 5 is a flowchart schematically showing a method for driving a power switch in accordance with another embodiment of the present invention, FIG. 6 is a flowchart schematically showing a method for driving a power switch in accordance with another embodiment of the present invention, and FIG. 7 is a flowchart schematically showing a method for driving a power switch in accordance with another embodiment of the present invention.

Referring to FIGS. 5, 6, and/or 7, a method for driving a power switch according to an example may include the step S100, S100′, and S100″ of generating and outputting a reference signal for duty control and the step S300 of generating and outputting a duty control signal for driving a power switch. Further, referring to FIG. 7, in another example, the method for driving a power switch may further include the step S200 of outputting a feedback signal and the step S500 of driving a power switch.

Referring to 5, 6, and/or 7, in the step S100, S100′, and S100″ of generating and outputting the reference signal for duty control, a variable oscillator 10 generates and outputs the reference signal for duty control of which the frequency varies according to a change in primary side input voltage.

For example, in an example, in the step of generating and outputting the reference signal for duty control, the frequency of the reference signal for duty control may be reduced when the primary side input voltage is increased.

At this time, referring to FIGS. 6 and/or 7, in an example, the step S100′ and S100″ of generating and outputting the reference signal for duty control may include the step S110 of generating, outputting, and applying the reference signal for duty control and the step S130 of generating and feeding back a triangular wave signal. At this time, in the step S110 of generating, outputting, and applying the reference signal for duty control, the signal according to the primary side input voltage and the fed-back triangular wave signal are received and compared S111. Further, in the step S110 of generating, outputting, and applying the reference signal for duty control, the reference signal for duty control, which is generated as a result of the comparison, is output for generation of the duty control signal and applied to an oscillator switch 11a at the same time S113. Next, the step S130 of generating and feeding back the triangular wave signal will be described. In the step S130 of generating and feeding back the triangular wave signal, the triangular wave signal, of which the frequency varies according to a switching operation of the oscillator switch 11a according to the application of the reference signal for duty control, is generated. Further, in the step S130 of generating and feeding back the triangular wave signal, the triangular wave signal with a variable frequency is fed back to the step S130 of generating, outputting, and applying the reference signal for duty control for the comparison with the signal according to the primary side input voltage in the step S110 of generating, outputting, and applying the reference signal for duty control.

Referring to FIG. 7, in an example, the step S100″ of generating and outputting the reference signal for duty control may further include the step S105 of receiving the signal of the primary side input voltage from a buffer amplifier 15 to transmit the received signal to the step S110 of generating, outputting, and applying the reference signal for duty control for the comparison with the fed-back triangular wave signal.

Next, referring to FIGS. 5, 6, and/or 7, in the step S300 of generating and outputting the duty control signal for driving the power switch, the duty control signal for driving the power switch is generated and output by receiving the feedback signal fed back from the secondary side output signal and the reference signal for duty control from a duty control unit 30.

For example, referring to FIG. 7, in an example, the method for driving a power switch may further include the step S200 of outputting the feedback signal and the step S500 of driving the power switch. At this time, in the step S200 of outputting the feedback signal, the feedback signal is output for the generation of the duty control signal by detecting the secondary side output signal. Further, in the step S500 of driving the power switch, the driving signal for driving the power switch 110 is generated and output according to the duty control signal output in the step S300 of generating and outputting the duty control signal.

According to the embodiments of the present invention, it is possible to improve the switching loss by varying the frequency of the reference signal for duty control of the power switch according to the input voltage.

Further, according to an example, it is possible to prevent the switching loss from increasing according to the increase in the input voltage of the SMPS.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A circuit for driving power switch, comprising:
a variable oscillator for varying a frequency according to a change in primary side input voltage to output a reference signal for duty control; and
a duty control unit for receiving a feedback signal fed back from a secondary side output signal and the reference signal for duty control from the variable oscillator and outputting a duty control signal for driving a power switch.

2. The circuit for driving power switch according to claim 1, wherein the variable oscillator comprises:
a triangular wave generator for generating a triangular wave signal of which the frequency varies depending on a switching operation of an oscillator switch according to the output reference signal for duty control; and
a comparator for inputting and comparing the signal according to the primary side input voltage and the triangular wave signal output from the triangular wave generator, and outputting the reference signal for duty control of which the frequency varies according to the change in the primary side input voltage and the change in the frequency of the triangular wave signal.

3. The circuit for driving power switch according to claim 2, wherein the variable oscillator further comprises a buffer amplifier for receiving the signal of the primary side input voltage to transmit the received signal to the comparator.

4. The circuit for driving power switch according to claim 3, wherein the triangular wave generator comprises:
a current source;
a charging and discharging capacitor connected to the current source and generating the triangular wave signal by repeating charging and discharging using the current source as a power supply for charging according to the switching operation; and
the oscillator switch connected in parallel to the charging and discharging capacitor on a lower end of the current source, performing the switching operation according to the reference signal for duty control, discharging a charging voltage of the charging and discharging capacitor to a ground when turned on, and performing charging to the charging and discharging capacitor from the current source when turned off.

5. The circuit for driving power switch according to claim 1, wherein the variable oscillator reduces the frequency of the reference signal for duty control when the primary side input voltage is increased to output the reference signal for duty control of which the frequency is reduced.

6. The circuit for driving power switch according to claim 2, wherein the variable oscillator reduces the frequency of the reference signal for duty control when the primary side input voltage is increased to output the reference signal for duty control of which the frequency is reduced.

7. The circuit for driving power switch according to claim 4, wherein the variable oscillator reduces the frequency of the reference signal for duty control when the primary side input voltage is increased to output the reference signal for duty control of which the frequency is reduced.

8. The circuit for driving power switch according to claim 5, further comprising:
a feedback circuit unit for receiving the detected secondary side output signal to feed back the feedback signal to the duty control unit; and
a switch driving unit for outputting a driving signal for driving a power switch according to the duty control signal of the duty control unit.

9. A power supply apparatus comprising:
a transformer for generating a secondary side output voltage by receiving a primary side input voltage;
a secondary output block connected to a secondary side of the transformer to supply a secondary side output signal to a load;
the circuit for driving power switch according to claim 1; and
a power switch driven by the circuit for driving power switch.

10. The power supply apparatus according to claim 9, wherein the variable oscillator of the circuit for driving power switch comprises:
a triangular wave generator for generating a triangular wave signal of which the frequency varies depending on a switching operation of an oscillator switch according to the output reference signal for duty control; and
a comparator for inputting and comparing the signal according to the primary side input voltage and the triangular wave signal output from the triangular wave generator, and outputting the reference signal for duty control of which the frequency varies according to the change in the primary side input voltage and the change in the frequency of the triangular wave signal.

11. The power supply apparatus according to claim 10, wherein the variable oscillator further comprises a buffer amplifier for receiving the signal of the primary side input voltage to transmit the received signal to the comparator, and
the triangular wave generator comprises:
a current source;
a charging and discharging capacitor connected to the current source and generating the triangular wave signal by repeating charging and discharging using the current source as a power supply for charging according to the switching operation; and
the oscillator switch connected in parallel to the charging and discharging capacitor on a lower end of the current source, performing the switching operation according to the reference signal for duty control, discharging a charging voltage of the charging and discharging capacitor to a ground when turned on, and performing charging to the charging and discharging capacitor from the current source when turned off.

12. The power supply apparatus according to claim 9, wherein the variable oscillator of the circuit for driving power switch reduces the frequency of the reference signal for duty control when the primary side input voltage is increased to output the reference signal for duty control of which the frequency is reduced.

13. The power supply apparatus according to claim 9, wherein the circuit for driving power switch further comprises:
a voltage division unit for dividing the primary side input voltage to provide the divided voltage to the variable oscillator;
a feedback circuit unit for detecting the secondary side output signal to feed the feedback signal back to the duty control unit; and
a switch driving unit for outputting a driving signal for driving the power switch according to the duty control signal of the duty control unit.

14. A method for driving a power switch, comprising:
generating and outputting a reference signal for duty control of which the frequency varies according to a change in primary side input voltage; and
generating and outputting a duty control signal for driving a power switch after receiving a feedback signal fed back from a secondary side output signal and the reference signal for duty control.

15. The method for driving a power switch according to claim 14, wherein generating and outputting the reference signal for duty control comprises:
receiving and comparing the signal according to the primary side input voltage and a fed-back triangular wave signal, and outputting the reference signal for duty control, which is generated as a result of the comparison, for generation of the duty control signal and applying the reference signal for duty control to an oscillator switch at the same time; and
generating the triangular wave signal of which the frequency varies depending on a switching operation of the oscillator switch according to the application of the reference signal for duty control and feeding back the triangular wave signal for comparison.

16. The method for driving a power switch according to claim 15, wherein generating and outputting the reference signal for duty control further comprises:
in a buffer amplifier, receiving the signal of the primary side input voltage to transmit the received signal for comparison with the fed-back triangular wave signal.

17. The method for driving a power switch according to claim 14, wherein generating and outputting the reference signal for duty control reduces the frequency of the reference signal for duty control when the primary side input voltage is increased to output the reference signal for duty control of which the frequency is reduced.

18. The method for driving a power switch according to claim 15, wherein generating and outputting the reference signal for duty control reduces the frequency of the reference signal for duty control when the primary side input voltage is increased to output the reference signal for duty control of which the frequency is reduced.

19. The method for driving a power switch according to claim 16, wherein generating and outputting the reference signal for duty control reduces the frequency of the reference signal for duty control when the primary side input voltage is increased to output the reference signal for duty control of which the frequency is reduced.

20. The method for driving a power switch according to claim 17, further comprising:
receiving the detected secondary side output signal and outputting the feedback signal for generation of the duty control signal; and
generating and outputting a driving signal for driving a power switch according to the duty control signal output in generating and outputting the duty control signal.
